(19) United States
(12) Patent Application Publication
(10) Pub. No.: US 2002/0189651 A1
(43) Pub. Date: Dec. 19, 2002

(54) Device and method for treating subtrates

(76) Inventors: Torsten Radtke, Dresden (DE); Klaus Wolke, Althengstett (DE)

Correspondence Address: Robert W Becker & Associates, Suite B, 707 Highway 66 East, Tijeras, NM, 87059, US

(21) Appl. No.: 10/168,354

(22) PCT Filed: Dec. 8, 2000
(86) PCT No.: PCT/EP00/12428

(30) Foreign Application Priority Data
Dec. 14, 1999 (DE) 199 60 241.7

(51) Int. Cl. B08B 3/04

(52) U.S. Cl. 134/34; 134/902; 134/183

(57) ABSTRACT

In order to optimize flow conditions in a device (1) for treating substrates (2) in a treatment basin (3) that is filled with treatment fluid, said device comprising at least one diffusor (12) to introduce the fluid into the treatment basin (3), the distance between the diffusor (12) and the substrates (2) can be regulated. The invention also relates to a method for regulating said distance. According to an additional measure to improve flow conditions in said device, the diffusor (12) has a plate (18) that is curved cylindrically toward the substrates (2) and outlets (20), the cylindrical axes thereof extending perpendicularly in relation to the planes of the substrates.

The present invention relates to an apparatus and a method for the treatment of substrates in a treatment tank that is filled with treatment fluid, according to which the fluid is introduced via a diffusor into the treatment tank.

In manufacturing processes, especially in the semiconductor industry, it is necessary to treat substrates with a fluid. One example of this is the wet treatment of substrates during the manufacture of chips.

From EP-B-0 385 536 and DE 197 03 646 apparatus are known for the wet treatment of substrates in a tank that contains a treatment fluid, according to which the substrates, together with a substrate carrier, can be placed into the tank. The substrates, for example semiconductor wafers, are placed into the substrate carrier prior to the wet treatment. Subsequently, the semiconductor wafers, together with the substrate carrier, are placed into the tank that contains the treatment fluid. During the wet treatment of the wafers, treatment fluid is continuously introduced into the treatment tank via a diffusor that is disposed below the wafers.

In this connection, for a uniform treatment of the substrates it is important to provide uniform flow conditions upon the substrate surfaces. However, these conditions essentially depend upon the viscosity of the treatment fluid that is used, the arrangement of the element of the treatment tank, as well as the shape and size of the substrates that are to be treated. With the apparatus described above, it is not possible to adapt the flow conditions within the treatment tank to changing process conditions, such as, for example, the viscosity of the treatment fluid and/or the size and shape of the wafers, so that changing process conditions result in non-uniform flow conditions upon the surfaces of the substrates.

Proceeding from the aforementioned apparatus, it is an object of the present invention to provide an apparatus and a method to optimize the flow conditions, especially to provide a homogenization of the flows upon the substrates that are to be treated.

Pursuant to the invention, this object is realized with an apparatus of the aforementioned type in that the spacing between the diffusor and the substrates can be adjusted. In so doing, it is possible to have an individual adaptation to the respective process conditions, such as, for example, the viscosity of the treatment fluid or the arrangement of the elements in the tank, which can vary, for example, with different substrate carriers. Uniform flow conditions in the tank lead to, a more uniform treatment of the substrates, as a result of which damage to them is avoided. In particular, by reducing the spacing between diffusor and substrates it is possible to reduce the deflection pressure of the diffusor, as a result of which a more uniform flow is achieved.

Pursuant to a particularly preferred embodiment of the invention, the diffusor is displaceable in the treatment tank. In so doing, an adjustment of the spacing between diffusor and substrates can be achieved in a simple and efficient manner. Furthermore, access to the diffusor for maintenance and/or exchange purposes is considerably simplified due to the displaceability. Such a monitoring and/or exchange of the diffusor is necessary, for example, if foreign particles collect upon the diffusor, which can lead to contamination of the treated substrates.

Pursuant to a further embodiment of the invention, the position of a substrate-holding device in the treatment tank is preferably adjustable. Substrate-holding devices are generally moveable in the treatment tank for the insertion and removal of the substrates from the treatment tank. Therefore, the positioning thereof for the adjustment of the spacing is particularly simple. The apparatus preferably has a control device for controlling the position of the diffusor and/or of the substrate-holding device in order to undertake an adjustment of the spacing that is adapted to the process conditions.

Pursuant to a further preferred embodiment of the invention, the diffusor has a diffusor plate that is cylindrically curved relative to the substrates and is provided with discharge or outlet openings, the cylinder axes of which extend perpendicular to the planes of the substrates. As a consequence of the cylindrically curved diffusor plate, a wide-surface introduction of the treatment fluid into the treatment tank is possible. In so doing, the introduction pressure relative to a diffusor can be reduced via a smaller introduction surface, which leads to improved uniformity of the flow. Furthermore, due to the curvature individual streams result that diverge in a fan-shaped manner from the diffusor. This prevents a crossing-over of the streams and turbulence, which adversely affect the uniformity of the overall flow.

For a uniform flow within the treatment tank, the shape of the diffusor plate is preferably symmetrical relative to its apex. The outlet openings are also preferably arranged symmetrically relative to the apex.

In order to achieve a pressure distribution at all of the outlet openings that is as uniform as possible, a deflection or baffle plate is preferably provided that is disposed across from an inlet of the diffusor.

The above-mentioned object is also realized by a apparatus of the aforementioned type in that the diffusor is provided with a diffusor plate that is cylindrically curved relative to the substrates and that is provided with outlet openings, the cylinder axes of which extend perpendicular to the planes of the substrates. As already mentioned, the cylindrical curvature of the diffusor plate enables a wide-surface introduction of the treatment fluid into the treatment tank. Furthermore, a flow that diverges in a fan-shaped manner from the diffusor is produced, so that no flows that cross over and hence no turbulence results, which leads to a very uniform flow.

For a flow within the treatment tank that is as uniform as possible, the shape of the diffusor plate is preferably symmetrical relative to its apex. The outlet or discharge points are preferably also disposed symmetrically relative to the apex.

In order to provide a pressure distribution at all of the outlet openings of the diffusor plate that is as uniform as possible, a deflection or baffle plate is preferably provided that is disposed across from an inlet of the diffusor.

The object of the invention is realized by a method for the treatment of substrates in a treatment tank that is filled with treatment fluid, according to which the fluid is introduced into the treatment tank via a diffusor, in that the spacing between diffusor and substrate is adjusted as a function of the process conditions. By adjusting the spacing, the flow conditions within the treatment tank, and hence the treatment success that is achieved, are homogenized, whereby changing process conditions are accommodated.

Pursuant to a particularly preferred embodiment of the invention, the spacing is adjusted as a function of the viscosity of the fluid, since this has a great influence upon the flow within the treatment tank. The spacing is preferably adjusted by displacing the diffusor in the treatment tank. Pursuant to a further embodiment of the invention, the spacing is adjusted by displacing a substrate-holding device in the treatment tank.

The inventive apparatus and the inventive method are particularly suitable for the wet treatment of semiconductor wafers, especially in so-called individual treatment tanks or Single-Tank-Tools, in which different treatment fluids are used within a single tank for the treatment of the wafers.

The invention will be described in greater detail subsequently with the aid of preferred embodiments and reference to the figures; shown are:

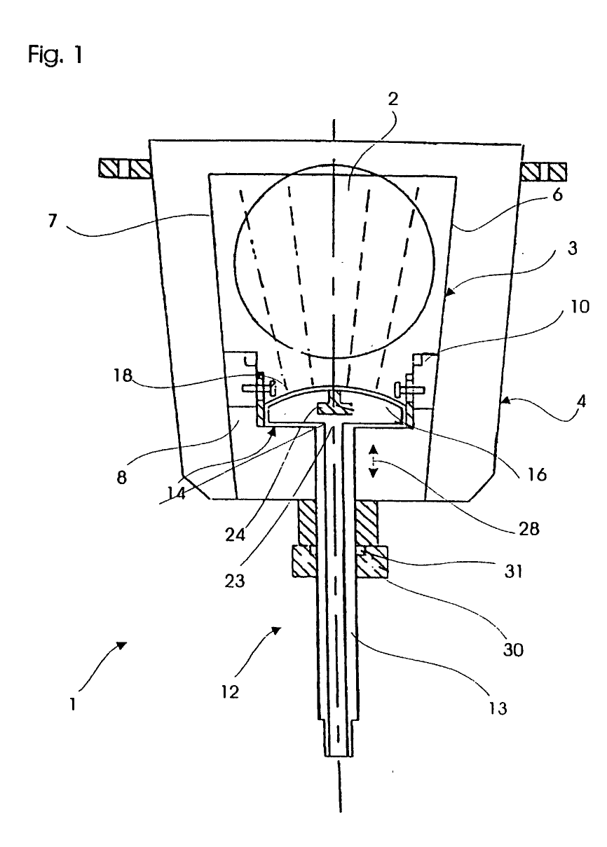

FIG. 1 a schematic cross-sectional view through a treatment apparatus pursuant to the present invention;

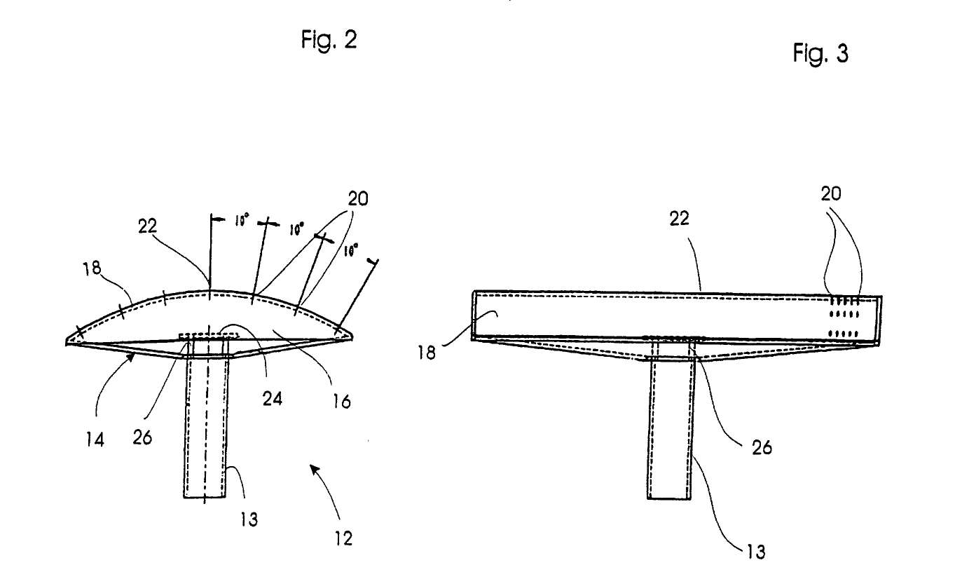

FIG. 2 a schematic side view of a diffusor pursuant to the present invention;

FIG. 3 a schematic side view of the diffusor of FIG. 2 at a viewing angle rotated by 90 degrees;

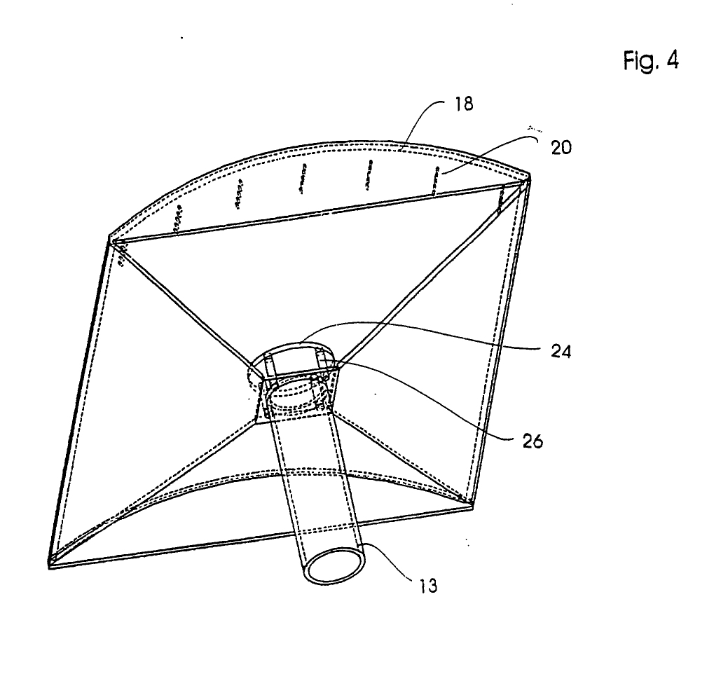

FIG. 4 a schematic perspective view of a diffusor pursuant to the present invention.

FIG. 1 shows an apparatus 1 for the treatment of substrates 2, such as, for example, semiconductor wafers, with a treatment tank 3 and an overflow 4 that surrounds the treatment tank. In the direction of viewing pursuant to FIG. 1, a plurality of wafers are accommodated in the treatment tank and are disposed one behind the other. The treatment tank 3 is provided with side walls 6, 7 that widen conically upwardly, as well as a bottom 8. Provided in a lower portion of the treatment tank 3 is a carrier receiving means 10 for receiving a wafer carrier, which is not illustrated in detail.

A diffusor unit 12 is also provided in the lower region of the treatment tank 3. The diffusor unit 12 is provided with a diffusor tube 13 that extends through the bottom 8, and a diffusor head 14 that is disposed above the bottom 8. The diffusor head 14 forms a chamber 16, which in the direction of the treatment tank is delimited by a cylindrically curved diffusor plate 18 that has outlet openings 20, which can be seen best in FIGS. 2-4. The cylinder axes of the diffusor plate 18 extends, pursuant to FIG. 1, into the plane of the drawing sheet and thus extends perpendicular to the wafers. As can be seen in FIG. 2, in the direction of curvature the outlet openings 20 are spaced from one another by an angular spacing of 10 degrees. Of course, other angular spacings between the openings 20 are also possible. The distance or spacing of the outlet openings transverse to the direction of curvature is adapted to the spacing of the wafers that are to be accommodated in the treatment tank such that the openings are respectively directed into the spaces formed between the wafers in order to provide a directed flow into these spaces or gaps. In the direction of curvature, the diffusor plate 18 has a shape that is symmetrical relative to its apex 22, and the openings 20 are similarly symmetrically arranged relative to the apex 22.

The diffusor tube 13 extends essentially perpendicular to the apex 22 of the curved diffusor plate, and has an opening 23 that faces the apex. In order to achieve as uniform a pressure distribution as possible at all discharge or outlet openings 20 of a treatment fluid that is introduced into the diffusor head 14 through the diffusor tube 13, there is provided between the curved diffusor plate and the opening 23 of the diffusor tube 13 a deflection or baffle element 24 in the form of a deflection or baffle plate. The baffle plate 14 can be secured to the curved diffusor plate 18, as illustrated in FIG. 1, or, as illustrated in FIGS. 2-4, it can be secured via suitable fastening and spacer elements 26 to the diffusor tube 13 or a base plate that is disposed across from the diffusor plate.

The diffusor tube 13 is longitudinally displaceable through the bottom 8 of the treatment tank 3, as illustrated by the double arrow 28 in FIG. 1. As a result of a longitudinal displacement of the diffusor tube, the diffusor head 14 that is fixedly mounted thereon is displaced longitudinally within the treatment tank 3, and the spacing or distance between the diffusor plate 18 and the semiconductor wafers 2 accommodated in the treatment tank 3 is altered.

The diffusor tube is guided through a suitable screw coupling or fixture 30 and an O-ring 31, and is secured to the tank 3. For a treatment of the semiconductor wafers 2, these wafers are placed into the treatment tank 3 via a holder or carrier that is not illustrated in detail. Subsequently, a treatment fluid, such as, for example, diluted hydrofluoric acid (DHF), is introduced into the treatment tank 3 by means of the diffusor unit 12. In so doing, the fluid is introduced through the diffusor tube 13 into the chamber 16 of the diffusor head 14. The fluid is diverted or deflected at the baffle plate 24 and is uniformly distributed in the chamber 16. Subsequently, it exits through the openings 20 in the curved diffusor plate 18. In so doing, a fluid stream that diverges in a fan-shaped manner is generated within the treatment tank 3, as schematically illustrated in FIG. 1. Depending upon the viscosity of the treatment fluid that is used, the shape and size of the semiconductor wafers 2 that are to be treated, the shape of the carrier, and/or of the treatment tank 3, the spacing between the wafers 2 and the diffusor unit 12 is adjusted by longitudinal displacement of the diffusor tube 13. For the adjustment, one can, for example, refer to a look-up table in which are given the various spacing values between diffusor plate 18 and wafer 2 for different viscosities of the treatment fluid, size and shape of the wafers 2, of the wafer carrier and/or of the tank 3. Of course, the spacing can also be adjusted as a function of other process parameters, such as, for example, the treatment fluid pressure, as a result of which a uniform fluid stream upon the wafer surfaces is achieved.

The invention was previously described with the aid of a preferred embodiment, without, however, being limited to this special embodiment. For example, it would be possible to effect the spacing between diffusor and wafer by different height positioning of the wafer carrier or of some other wafer-holding element. In particular, the invention is not limited to an apparatus according to which the wafers are inserted into the treatment tank with a wafer carrier. It is also to be understood that various forms of the diffusor unit as well as of the treatment tank are possible.

1. Apparatus (1) for the treatment of substrates (2) in a treatment tank (3) that is filled with treatment fluid, with at least one diffusor (12) for the introduction of the fluid into the treatment tank (3), characterized in that the spacing between the diffusor (12) and the substrates (2) is adjustable.

2. Apparatus (1) according to claim 1, characterized in that the diffusor (12) is displaceable in the treatment tank (3).

3. Apparatus (1) according to claim 1 or 2, characterized in that the position of a substrate-holding device in the treatment tank (3) is adjustable.

4. Apparatus (1) according to one of the preceding claims, characterized by a control device for the control of the position of the diffusor (12) and/or the substrate-holding device.

5. Apparatus (1) according to one of the preceding claims, characterized in that the diffusor (12) is provided with a diffusor plate (18) that is cylindrically curved relative to the substrates (2) and is provided with outlet openings (20), the cylinder axes of which extend perpendicular to the planes of the substrates.

6. Apparatus (1) according to claim 5, characterized in that the shape of the diffusor plate (18) is symmetrical relative to its apex (22).

7. Apparatus (1) according to claim 6, characterized in that the outlet openings (20) are disposed symmetrical relative to the apex (22).

8. Apparatus (1) according to one of the preceding claims, characterized by a deflection or baffle plate (24) that is disposed across from an inlet of the diffusor.

9. Apparatus (1) for the treatment of substrates (2) in a treatment tank (3) that is filled with treatment fluid, with a diffusor (12) for the introduction of the fluid into the treatment tank (3), characterized in that the diffusor (12) is provided with a diffusor plate (18) that is cylindrically curved relative to the substrates (2) and has outlet openings (20), the cylinder axes of which extend perpendicular to the planes of the substrates.

10. Apparatus (1) according to claim 9, characterized in that the shape of the diffusor plate (18) is symmetrical to its apex (22).

11. Apparatus (1) according to claim 10, characterized in that the outlet openings (20) are disposed symmetrical to the apex (22).

12. Apparatus (1) according to one of the claims 9 to 11, characterized by a deflection or baffle plate (24) that is disposed across from an inlet of the diffusor.

13. Method for the treatment of substrates in a treatment tank that is filled with treatment fluid, according to which the fluid is introduced via a diffusor into the treatment tank, characterized in that the spacing between diffusor and substrate is adjusted as a function of the process conditions.

14. Method according to claim 13, characterized in that the spacing is adjusted as a function of the viscosity of the fluid.

15. Method according to claim 13 or 14, characterized in that the spacing is adjusted by displacing the diffusor in the treatment tank.

16. Method according to one of the claims 13 to 15, characterized in that the spacing is adjusted by displacing a substrate-holding device in the treatment tank.
